(19) United States
(12) Patent Application Publication
(10) Pub. No.: US 2025/0044261 A1
(43) Pub. Date: Feb. 6, 2025

(54) ANOMALY DETECTION DEVICE, ANOMALY DETECTION METHOD, AND RECORDING MEDIUM

(71) Applicant: Panasonic Intellectual Property Corporation of America, Torrance, CA (US)

(72) Inventors: Koji SETOH, Osaka (JP); Takahiro Kamai, Kyoto (JP)

(21) Appl. No.: 18/918,344

(22) Filed: Oct. 17, 2024

Related U.S. Application Data
(63) Continuation of application No. PCT/JP2023/003058, filed on Jan. 31, 2023.

(30) Foreign Application Priority Data
Apr. 28, 2022 (JP) 2022-074437

(51) Int. Cl. G01N 29/46; G01H 17/00

(52) U.S. Cl. CPC G01N 29/46; G01H 17/00

(57) ABSTRACT

An anomaly detection device includes: an obtainer that obtains tapping sound information indicating a tapping sound generated by tapping a tile that is bonded; and a detector that detects, from the tapping sound information, whether an anomaly is present in an adhesion state of the tile, based on a difference between rise times of sounds at respective frequencies in a predetermined frequency band that includes an inaudible range.

### CROSS REFERENCE TO RELATED APPLICATIONS

This is a continuation application of PCT International Application No. PCT/JP2023/003058 filed on Jan. 31, 2023, designating the United States of America, which is based on and claims priority of Japanese Patent Application No. 2022-074437 filed on Apr. 28, 2022. The entire disclosures of the above-identified applications, including the specifications, drawings and claims are incorporated herein by reference in their entirety.

### FIELD

The present disclosure relates to an anomaly detection device, an anomaly detection method, and a recording medium.

### BACKGROUND

Patent Literature (PTL) 1 discloses, for example, a technology for a user to visually inspect whether a void is present inside a structure from a scalogram displayed to the user. Such scalogram is generated by picking up, with a microphone, a percussion sound generated by hammering, and performing wavelet transform on the soundwaves of the picked-up sound.

### CITATION LIST

### Patent Literature

PTL 1: Japanese Patent No. 2610378

### SUMMARY

### Technical Problem

However, the technology described in PTL 1 requires the user to read the length of the duration of the percussion sound that is visually represented by the scalogram to determine whether a void is present inside the structure, which consumes time and manpower. In addition, since the determination results can differ from person to person, it is difficult to say that the reliability of such determination is high.

In view of the above, the present disclosure provides an anomaly detection device, an anomaly detection method, and a recording medium capable of detecting whether an anomaly is present in the adhesion state of a tile in an easy and accurate manner.

### Solution to Problem

The anomaly detection device according to an aspect of the present disclosure includes: an obtainer that obtains tapping sound information indicating a tapping sound generated by tapping a tile that is bonded; and a detector that detects, from the tapping sound information, whether an anomaly is present in an adhesion state of the tile, based on a difference between rise times of sounds at respective frequencies in a predetermined frequency band that includes an inaudible range.

### Advantageous Effects

According to the present disclosure, it is possible to provide an anomaly detection device, an anomaly detection method, and a recording medium capable of detecting whether an anomaly is present in the adhesion state of a tile in an easy and accurate manner.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram showing an example of the functional configuration of an anomaly detection system in an embodiment.

FIG. 2 is a diagram schematically showing an example of a hammering inspection performed on tiles.

FIG. 3 is a diagram for explaining the adhesion states of tiles.

FIG. 4 is a flowchart showing an example of an operation performed in the anomaly detection system in the embodiment.

FIG. 5 is a flowchart showing a detailed flow of step S02 in FIG. 4.

FIG. 6 is a diagram showing an example of tapping sound information on a tile.

FIG. 7 is a diagram showing an example in which the rise times of sounds at the respective frequencies are linearly approximated in a predetermined frequency band.

FIG. 8 is a diagram for explaining Example Operation 1 performed in a presentation step.

FIG. 9 is a diagram for explaining Example Operation 2 performed in the presentation step.

FIG. 10 is a diagram schematically showing the structure of a tile specimen.

FIG. 11 is a diagram showing the results of Example Experiment 1.

FIG. 12 is a diagram showing the results of Example Experiment 2.

FIG. 13 is a diagram showing the results of Example Experiment 3.

FIG. 14 is a diagram showing the results of Example Experiment 4.

FIG. 15 is a diagram showing the results of Example Experiment 5.

FIG. 16 is a diagram showing an example of a spectrogram generated through Fourier transform in Example Experiment 6 and a formula (Expression 1) for calculating a signal-to-noise ratio (SNR).

FIG. 17 is a diagram showing the results of SNR calculations in Example Experiment 6.

FIG. 18 is a block diagram showing an example of the functional configuration of an anomaly detection system in another embodiment.

### DESCRIPTION OF EMBODIMENT

### Summary of the Disclosure

The anomaly detection device according to an aspect of the present disclosure includes: an obtainer that obtains tapping sound information indicating a tapping sound generated by tapping a tile that is bonded; and a detector that detects, from the tapping sound information, whether an anomaly is present in an adhesion state of the tile, based on a difference between rise times of sounds at respective frequencies in a predetermined frequency band that includes an inaudible range.

With this, it is possible for the anomaly detection device to detect whether an anomaly is present in the adhesion state of a tile, on the basis of a difference between the rise times of the sounds at the respective frequencies in the predetermined frequency band. This eliminates the user's trouble of having to determine the presence or absence of an anomaly. It is thus possible for the anomaly detection device to detect whether an anomaly is present in the adhesion state of a tile in an easy and accurate manner.

In the anomaly detection device according to an aspect of the present disclosure, the difference between the rise times of the sounds may be a ratio (Δf/Δt) of an amount of change in the respective frequencies (Δf) to an amount of change in the rise times of the sounds (Δt) at the respective frequencies in the predetermined frequency band.

With this, it is possible for the anomaly detection device to detect whether an anomaly is present in the adhesion state of the tile, on the basis of the rate of change of the rise times of the sounds at the respective frequencies in the predetermined frequency band (i.e., the foregoing ratio).

The anomaly detection device according to an aspect of the present disclosure may further include a calculator that calculates the difference between the rise times of the sounds. In this anomaly detection device, the calculator may: extract, from the tapping sound information, time-series data on the sounds at the respective frequencies; approximate, by a straight line, the rise times of the sounds at the respective frequencies in the predetermined frequency band, based on the time-series data on the sounds at the respective frequencies; and calculate, as the ratio, a numeric value of a slope of the straight line.

With this, it is possible for the anomaly detection device to detect whether an anomaly is present in the adhesion state of the tile, on the basis of the slope of the straight line, which is obtained by linearly approximating the rise times of the sounds at the respective frequencies in the predetermined frequency band. With this, it is possible for the anomaly detection device to detect whether an anomaly is present in the adhesion state of the tile, on the basis of the relationship between the frequencies and the rise times of the sounds.

In the anomaly detection device according to an aspect of the present disclosure, a lower limit of the predetermined frequency band may be a frequency that corresponds to a predetermined period in which the rise times of the sounds at the respective frequencies are measured.

With this, it is possible for the anomaly detection device to set the lower limit of the predetermined frequency band in accordance with the measurement accuracy required by the user.

In the anomaly detection device according to an aspect of the present disclosure, an upper limit of the predetermined frequency band may be in the inaudible range and a frequency at which a signal-to-noise ratio is greater than or equal to a predetermined value.

With this, the upper limit frequency is set to a frequency, among the frequencies in the inaudible range, that is lower than or equal to the frequency at which noise of a certain level or higher exists. It is thus possible for the anomaly detection device to detect whether an anomaly is present in the adhesion state of the tile, on the basis of highly reliable data. The anomaly detection device is thus capable of improving the accuracy of detecting an anomaly in the adhesion state of the tile.

In the anomaly detection device according to an aspect of the present disclosure, each of the rise times of the sounds may be time at which a difference between a maximum value and a minimum value of a sound pressure exceeds a predetermined percentage.

With this, it is possible for the anomaly detection device to accurately measure the rise times of the sounds at the respective frequencies, even when the sound pressures at the respective frequencies are different.

The anomaly detection device according to an aspect of the present disclosure may further include a presenter that presents information to a user. In this anomaly detection device, the presenter may present the information indicating whether an anomaly is present in the adhesion state of the tile.

With this, it is possible for the anomaly detection device to present, to the user, whether an anomaly is present in the adhesion state of the tile, thereby assisting the user in easily grasping the presence or absence of an anomaly in the adhesion state of the tile.

The anomaly detection device according to an aspect of the present disclosure may further include a presenter that presents information to a user. In this anomaly detection device, the presenter may present the information in a form of a contour line that connects numeric values of slopes of straight lines of a plurality of tiles at a predetermined value interval, the numeric values of the slopes of the straight lines of the plurality of tiles each being the numeric value of the slope of the straight line of the tile.

With this, it is possible for the anomaly detection device to, for example, assist the user in easily grasping an area where an anomaly is likely to be present on a wall surface of a certain size range.

Also, the anomaly detection method according to an aspect of the present disclosure is an anomaly detection method performed by a computer. This anomaly detection method includes: obtaining tapping sound information indicating a tapping sound generated by tapping a tile that is bonded; and detecting, from the tapping sound information, whether an anomaly is present in an adhesion state of the tile, based on a difference between rise times of sounds at respective frequencies in a predetermined frequency band that includes an inaudible range.

With this, it is possible for a device that performs the anomaly detection method to detect whether an anomaly is present in the adhesion state of a tile, on the basis of a difference between the rise times of the sounds at the respective frequencies in the predetermined frequency band. This eliminates the user's trouble of having to determine the presence or absence of an anomaly. It is thus possible for the device that performs the anomaly detection device to detect whether an anomaly is present in the adhesion state of a tile in an easy and accurate manner.

Also, the program according to an aspect of the present disclosure is a program for causing a computer to execute the anomaly detection method described above.

With this, it is possible to achieve the same effects as those achieved by the anomaly detection method described above, using a computer.

These general or specific aspects may be implemented using a system, a method, a device, an integrated circuit, a computer program, or a computer-readable recording medium such as a compact disc read only memory (CD-ROM), or any combination of systems, methods, devices, integrated circuits, computer programs, or recording media

Hereinafter, a certain exemplary embodiment is described in greater detail with reference to the accompanying Drawings. The numeric values, shapes, materials, elements, the arrangement and connection of the elements, steps, the processing order of the steps etc. shown in the following exemplary embodiment are mere examples, and therefore do not limit the scope of the appended Claims. Therefore, among the elements in the following exemplary embodiment, those not recited in any one of the independent Claims are described as optional elements. Also note that the drawings are not always exactly illustrated. Also, substantially the same elements are assigned the same reference marks throughout the drawings, and overlapping description may be omitted or simplified.

Also, in the present disclosure, terms such as “parallel” and “vertical” that indicate the relationship between elements, terms such as “rectangular shape” that indicates the shape of an element, and numeric values do not indicate precise meanings only and thus encompass and cover the substantially equivalent ranges that are, for example, different by approximately several percent.

### Embodiment

Hereinafter, a certain exemplary embodiment is described in greater detail with reference to the accompanying Drawings.

### [1. Overview]

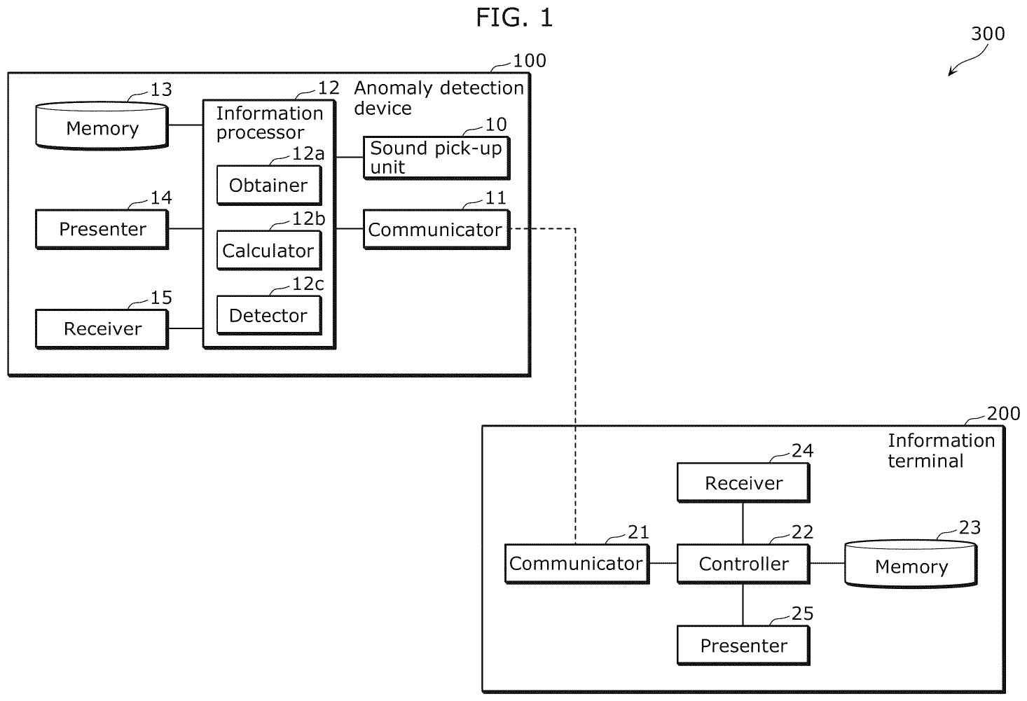

First, an overview of the anomaly detection system in an embodiment is described. FIG. 1 is a block diagram showing an example of the functional configuration of anomaly detection system 300 in the embodiment.

Anomaly detection system 300 is, for example, a system that obtains tapping sound information indicating a tapping sound generated by tapping a tile that is bonded, and detects, from the obtained tapping sound information, whether an anomaly is present in the adhesion state of the tile, on the basis of a difference between the rise times of sounds at the respective frequencies in a predetermined frequency band that includes an inaudible range.

Anomaly detection system 300 presents, for example, whether an anomaly is present in the adhesion state of the tile to a user. For example, anomaly detection system 300 may present the detection result to the user every time it detects whether an anomaly is present in the adhesion state of a tile, or may present the detection results to the user after detecting whether an anomaly is present in the adhesion states of a plurality of tiles. A method of presenting the detection results may either be in the form of sound output or image display, or may be both of these.

Anomaly detection system 300 may also present the detection results on the plurality of tiles, in the form of a contour line that connects the numeric values of the slopes of straight lines, each being obtained by approximating the rise times of the sounds at the respective frequencies in the predetermined frequency band, at predetermined value intervals. Note that specific forms of display are described in detail later.

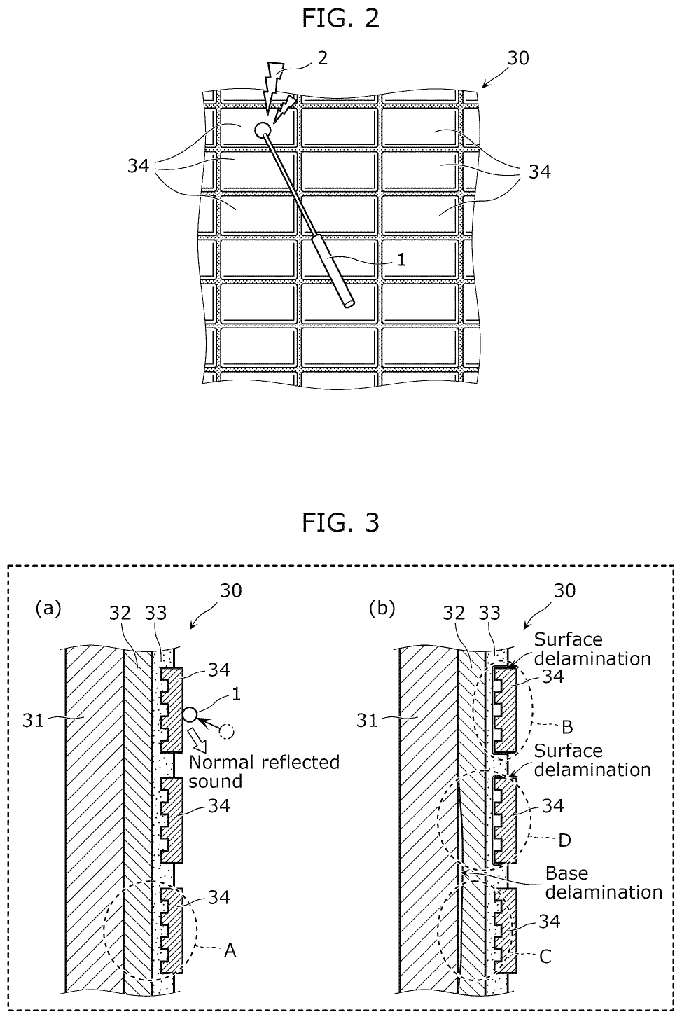

FIG. 2 is a diagram schematically showing an example of a hammering inspection performed on tiles. As shown in FIG. 2, the hammering inspection on tiles 34 is usually performed by a person by tapping tiles 34 on the surface of wall 30 one by one with tapping means 1 such as a tapping rod, to determine whether an anomaly is present in the adhesion states of tiles 34, on the basis of the tapping sounds of tiles 34. The tapping sound of tile 34 is sound 2 that is generated when tile 34 is tapped with tapping means 1. In the present disclosure, tile 34 may be tapped by a person using tapping means 1, or by a robot using tapping means 1. These are mere examples, and thus the present disclosure is not limited to these.

Tile 34 is a building component fixed to a surface of the building frame with, for example, adhesive or mortar. Tile 34 is not limited to being made of wood, ceramics, clay, or stone, and thus may also be made using a material such as carbon fiber reinforced plastics (CFRP), metal, resin, glass, etc. More specifically, tile 34 is bonded to a surface of a wall (exterior wall or interior wall) when adhesive or mortar placed between the surface of the building frame and the tile becomes harden.

FIG. 3 is a diagram for explaining the adhesion states of tiles 34. In FIG. 3, (a) shows an example in which the adhesion states of tiles 34 are normal, and (b) shows an example in which the adhesion states of tiles 34 are anomalous.

As shown in (a) in FIG. 3, wall 30, on the surface of which tiles 34 are bonded (referred to as “tile wall”), includes: frame 31, such as a base concrete layer; intermediate layer 32 (e.g., intermediate mortar layer) for fixing tiles 34 to the surface of frame 31; adhesive layer 33 (e.g., adhesive mortar layer); and a plurality of tiles 34. For example, dashed line portion A in (a) in FIG. 3 indicates that the adhesion state of tile 34 is normal.

Meanwhile, as shown in (b) in FIG. 3, anomalies in the adhesion states of tiles 34 include, for example, surface delamination (e.g., dashed line portion B), base delamination (e.g., dashed line portion C), and surface delamination with base delamination (e.g., dashed line portion D). Surface delamination is a state in which a void is formed between adhesive layer 33 and tile 34. Base delamination is a state in which a void is formed between frame 31 and intermediate layer 32. When such a void is formed, the rise times of the sounds at the respective frequencies in the predetermined frequency band of the tapping sound of tile 34 are approximately the same time. Meanwhile, when the adhesion state of tile 34 is normal, the rise times of the sounds at the respective frequencies in the predetermined frequency band of the tapping sound of tile 34 are approximately the same time at frequencies lower than a predetermined frequency (e.g., 40 kHz) (a range of such frequencies is referred to as “low frequency band”), and are later at frequencies that are higher than the predetermined frequency (e.g., 40 kHz) (a range of such frequencies is referred to as “high frequency band”) than in the low frequency band. Note that the predetermined frequency may be, for example, an intermediate frequency in the predetermined frequency band.

Each of the rise times of the sounds at the respective frequencies is the time at which the difference between the maximum value and the minimum value of the sound pressure at such frequency exceeds a predetermined percentage (e.g., 75%).

The predetermined frequency band includes the inaudible range. The predetermined frequency band may or may not include the audible range. The upper limit of the predetermined frequency band is a frequency, in the inaudible range, at which the signal-to-noise ratio (SNR) is greater than or equal to a predetermined value (e.g., 40 dB). Also, the lower limit of the predetermined frequency band is a frequency that corresponds to a predetermined period (e.g., 0.1 msec) in which the rise times of the sounds at the respective frequencies are measured.

An inaudible sound is a sound in a range of frequencies that cannot be detected by human ears (in other words, beyond human hearing), or more specifically, a sound in a frequency band of 20 kHz or higher (known as “ultrasonic frequency band”). Note that an audible sound is a sound in a range of frequencies that can be detected by human ears (in other words, audible by human ears), or more specifically, a sound in a frequency band of 20 Hz or higher and less than 20 kHz.

A difference between the rise times of the sounds is, for example, the ratio (Δf/Δt) of the amount of the change in frequency (Δf) to the amount of the change in the rise times of the sounds at the respective frequencies (Δt) in the predetermined frequency band, but may also be the amount of the change in the rise times of the sounds at the respective frequencies (Δt) in the predetermined frequency band.

### [2. Configuration]

Next, with reference to FIG. 1, the configuration of anomaly detection system 300 is described. Anomaly detection system 300 includes, for example, anomaly detection device 100 and information terminal 200. The following describes the configurations of anomaly detection device 100 and information terminal 200.

### [2-1. Anomaly Detection Device 100]

Anomaly detection device 100 according to the embodiment obtains the tapping sound information on each of the tiles that are bonded, and detects, from the obtained tapping sound information, whether an anomaly is present in the adhesion state of the tile, on the basis of a difference between the rise times of the sounds at the respective frequencies in the predetermined frequency band that includes the inaudible range.

Anomaly detection device 100 includes, for example, sound pick-up unit 10, communicator 11, information processer 12, memory 13, presenter 14, and receiver 15. The following describes each of these elements.

### [Sound Pick-Up Unit 10]

Sound pick-up unit 10 picks up the tapping sound of each of the tiles. Sound pick-up unit 10 is capable of picking up sounds from the audible range to the inaudible range. More specifically, sound pick-up unit 10 is a microphone, which may be, for example, a micro electro mechanical systems (MEMS) microphone or a laser microphone. In the case where sound pick-up unit 10 is a laser microphone, for example, sound pick-up unit 10 is capable of picking up sounds in a wider band than an ordinary microphone. In addition, since the laser microphone does not include a diaphragm that is included in an ordinary microphone, it is possible to pick up sounds even in an environment subjected to, for example, electromagnetic waves, high temperature, high heat, etc.

FIG. 1 shows an example in which anomaly detection device 100 includes one sound pick-up unit 10, but anomaly detection device 100 may include two or more sound pick-up units 10. Sound pick-up unit 10 may also be a directional microphone. With this, sound pick-up unit 10 is less likely to pick up noise sound, such as ambient noise, and thus is capable of highly sensitive picking up of the tapping sounds of the tiles.

Sound pick-up unit 10 converts the picked-up sound (tapping sound of each of the tiles) into an electrical signal, and outputs the electrical signal to information processor 12.

### [Communicator 11]

Communicator 11 is a communication circuit (communication module) for anomaly detection device 100 to communicate with information terminal 200. Communicator 11 includes a communication circuit (communication module) for performing communication via a local communication network, but may also include a communication circuit (communication module) for performing communication via a wide-area communication network. Communicator 11 is, for example, a wireless communication circuit that performs wireless communication, but may also be a wired communicator circuit that performs wired communication. Note that communication standard for communication performed by communicator 11 is not limited to a specific communication standard.

### [Information Processor 12]

Information processor 12 performs various information processing relating to anomaly detection device 100. More specifically, for example, information processor 12 obtains the electrical signal of the tapping sound of each of the tiles picked up by sound pick-up unit 10, and performs various information processing relating to the detection of whether an anomaly is present in the adhesion state of the tile. Upon obtaining the electrical signal of the tapping sound of each of the tiles, information processor 12 generates tapping sound information by, for example, performing Fourier transform or wavelet transform on the obtained electrical signal. More specifically, information processor 12 includes obtainer 12a, calculator 12b, and detector 12c. The functions of obtainer 12a, calculator 12b, and detector 12c are realized by means of a processor or a microcomputer included in information processor 12 executing a computer program stored in memory 13.

[Obtainer 12a]

Obtainer 12a obtains, for example, the tapping sound information on each of the tiles picked up by sound pick-up unit 10. The tapping sound information may be a spectrogram image generated by Fourier-transforming the electrical signal of the tapping sound of each of the tiles picked up by sound pick-up unit 10, or may be a scalogram image (time-frequency analysis image) generated by wavelet-transforming such electrical signal. The tapping sound information may also be time-series numeric value data of these images, or may be time-series numeric value data extracted by a plurality of bandpass filters that extract predetermined frequency components.

[Calculator 12b]

Calculator 12b calculates, for example, a difference between the rise times of the sounds. The difference between the rise times of the sounds is, for example, the ratio (Δf/Δt) of the amount of the change in frequency (Δf) to the amount of the change in the rise times of the sounds (Δt) at the respective frequencies in the predetermined frequency band. This ratio indicates the rate of the change in the rise times of the sounds at the respective frequencies in the predetermined frequency band. Calculator 12b may also extract time-series data on the sounds at the respective frequencies from the tapping sound information on each of the tiles obtained by obtainer 12a, for example, and calculate, as the foregoing ratio, the numeric value of the slope of a straight line that is obtained by approximating the rise times of the sounds at the respective frequencies in the predetermined frequency band (hereinafter also referred to as “approximate straight line”), on the basis of the time-series data on the sounds at the respective frequencies. The details of the ratio (Δf/Δt) and the slope of the approximate straight line are described later in the section [3. Operation].

The upper limit of the predetermined frequency band is, for example, a frequency, in the inaudible range, at which the SNR is greater than or equal to a predetermined value (e.g., 40 dB). Also, the lower limit of the predetermined frequency band is, for example, a frequency (e.g., 10 kHz) that corresponds to a predetermined period (e.g., 0.1 msec) in which the rise times of the sounds at the respective frequencies are measured.

[Detector 12c]

Detector 12c detects, from the tapping sound information obtained by obtainer 12a, whether an anomaly is present in the adhesion state of each of the tiles, on the basis of a difference between the rise times of the sounds at the respective frequencies in the predetermined frequency band that includes the inaudible range. More specifically, detector 12c may detect whether an anomaly is present in the adhesion state of each of the tiles, on the basis of the numeric value of the slope of the approximate straight line calculated by calculator 12b, or on the basis of the foregoing ratio (Δf/Δt). The details of the operation performed by detector 12c (detection processing) are described later in the section [3. Operation].

### [Memory 13]

Memory 13 is a recording device in which, for example, an exclusive application program to be executed by information processor 12 is stored. Memory 13 is realized, for example, by means of a hard disk drive (HDD), but may also be realized by means a semiconductor memory.

### [Presenter 14]

Presenter 14 presents information to the user. More specifically, presenter 14 presents, for example, whether an anomaly is present in the adhesion state of each of the tiles. Presenter 14 may also present, for example, whether an anomaly is present in the adhesion states of a plurality of tiles bonded to a portion of a wall surface of a building. For example, presenter 14 may present, in a tabular form, whether an anomaly is present, or a probability (accuracy) of an anomaly for each of the plurality of tiles. Also, for example, presenter 14 may present, for the plurality of tiles, a contour line that connects the numeric values of the slopes of the approximate straight lines calculated by calculator 12b at predetermined value intervals.

Presenter 14 is, for example, a display device that displays image information including text, etc. Presenter 14 may further include a sound output device that outputs sound information. The display device is, for example, a display that includes a liquid crystal (LC) panel or an organic electroluminescence (EL) panel as a display device. The sound output device is, for example, a speaker or earphones. For example, presenter 14 may display the image information onto the display device, or output the sound information through the sound output device, or may present both the image information and the sound information.

### [Receiver 15]

Receiver 15 is an input interface for receiving an operation input performed by the user who uses anomaly detection device 100. More specifically, receiver 15 is realized, for example, by means of a touch panel display. In the case where receiver 15 includes a touch panel display, for example, such touch panel display serves as presenter 14 and receiver 15. Note that receiver 15 is not limited to a touch panel display, and thus may also be, for example, a keyboard, a pointing device (e.g., stylus or mouse), a hardware button, etc. Receiver 15 may also be a microphone in the case of receiving a voice input. Receiver 15 may also be a camera in the case of receiving a gesture input. By receiver 15 receiving a user's operation input in the form of, for example, voice or gesture, it is possible for the user to use his/her hand relatively freely, thereby improving the convenience and workability of the user.

### [2-2. Information Terminal 200]

Information terminal 200 is a mobile information terminal, such as a laptop computer, a smartphone, or a tablet terminal used by the user of anomaly detection device 100, but may also be a stationary computer device. Information terminal 200 includes communicator 21, controller 22, memory 23, receiver 24, and presenter 25.

### [Communicator 21]

Communicator 21 is a communication circuit (communication module) for information terminal 200 to be connected with anomaly detection device 100 via a local communication network, but may also be a communication circuit (communication module) to be connected with anomaly detection device 100 via a wide-area communication network. Communication performed by communicator 21 is a wireless communication, but may also be a wired communication. The communication standard for communication performed by communicator 21 is not limited to a specific communication standard.

### [Controller 22]

Controller 22 performs various information processing relating to information terminal 200, on the basis of an operation input received by receiver 24. Controller 22 is realized, for example, by means of a microcomputer, but may also be realized by means of a processor.

### [Memory 23]

Memory 23 is a recording device in which, for example, an exclusive application program to be executed by controller 22 is stored. Memory 23 is realized, for example, by means of a semiconductor memory.

### [Receiver 24]

Receiver 24 is an input interface for receiving an operation input performed by a user who uses information terminal 200. For example, receiver 24 receives an input operation performed by the user for transmitting, to anomaly detection device 100, a method of presenting information. More specifically, receiver 24 is realized, for example, by means of a touch panel display. In the case where receiver 24 includes a touch panel display, for example, such touch panel display serves as presenter 25 and receiver 24. Note that receiver 24 is not limited to a touch panel display, and thus may also be, for example, a keyboard, a pointing device (e.g., stylus or mouse), a hardware button, etc. Receiver 24 may also be a microphone in the case of receiving a voice input. Receiver 24 may also be a camera in the case of receiving a gesture input.

### [Presenter 25]

Presenter 25 presents information outputted from anomaly detection device 100. The details of such information are the same as those described for presenter 14, and thus are not described here. Presenter 25 is, for example, a display device that displays image information including text, etc. Presenter 25 may further include a sound output device that outputs sound information. The display device is, for example, a display that includes an LC panel or an organic EL panel as a display device. The sound output device is, for example, a speaker or earphones. For example, presenter 25 may display the image information onto the display device, or output the sound information through the sound output device, or may present both the image information and the sound information.

### [3. Operation]

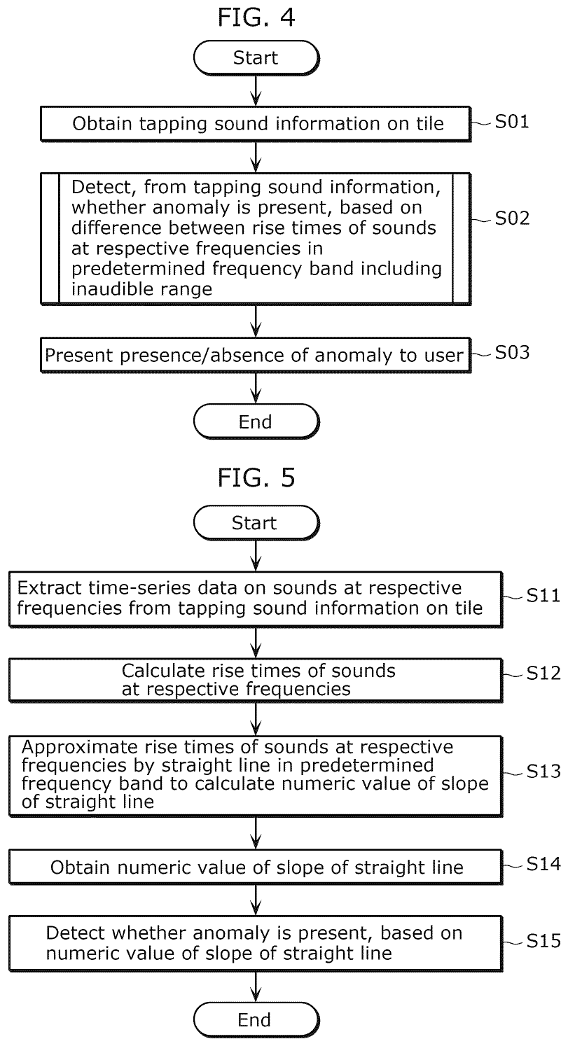

The following specifically describes the operation performed in anomaly detection system 300 in the embodiment with reference to the drawings. FIG. 4 is a flowchart showing an example of the operation performed in anomaly detection system 300 in the embodiment. Note that the example operation described below is a mere example, and thus the anomaly detection system and the anomaly detection method of the present disclosure are not limited to this.

For example, when receiver 24 of information terminal 200 receives an input operation for providing an instruction to start the anomaly detection processing, controller 22 of information terminal 200 outputs such instruction to anomaly detection device 100 via communicator 21 (not shown).

Next, when communicator 11 of anomaly detection device 100 obtains the instruction, information processor 12 causes sound pick-up unit 10 to start picking up sounds (not shown). Sound pick-up unit 10 is capable of picking up sounds in a wide band that includes the inaudible range. Sound pick-up unit 10, an example of which is a MEMS microphone, transmits an electrical signal of the picked-up sound (more specifically, tapping sound of each of the tiles) to information processor 12 (not shown). Upon obtaining the electrical signal of the sound transmitted from sound pick-up unit 10, information processor 12 of anomaly detection device 100 performs AD conversion on the obtained electrical signal of the sound and then performs wavelet transform on the resultant to generate a scalogram image (not shown). This scalogram image is an example of the tapping sound information on a tile.

Next, as shown in FIG. 4, obtainer 12a of anomaly detection device 100 obtains the tapping sound information on each of the tiles (S01). Here, the tapping sound information on each of the tiles is the scalogram image generated by wavelet-transforming the electric signal of the tapping sound of each of the tiles picked up by sound pick-up unit 10. However, the tapping sound information on each of the tiles may also be: a spectrogram image generated by Fourier-transforming the electric signal of the tile; time-series numeric value data of any of these transform images; time-series numeric value data extracted by a plurality of bandpass filters that extract predetermined frequency components.

Next, detector 12c of anomaly detection device 100 detects, from the tapping sound information on each of the tiles obtained by obtainer 12a in step S01, whether an anomaly is present in the adhesion state of the tile, on the basis of a difference between the rise times of the sounds at the respective frequencies in the predetermined frequency band that includes the inaudible range (S02).

Although example data is shown in the experimental examples to be described later, when an anomaly is present in the adhesion state of a tile, the rise times of the sounds at the respective frequencies in the predetermined frequency band are almost the same from low to high frequencies. However, when no anomaly is present in the adhesion state of a tile, the rise times of the sounds at the respective frequencies in the predetermined frequency band are later in the high frequency band above the predetermined frequency (40 kHz in the example experiments) than in the low frequency band below the predetermined frequency (40 kHz). Thus, when a difference between the rise times of the sounds at the respective frequencies in the predetermined frequency band is represented as the ratio (Δf/Δt) of the amount of the change in frequency (Δf) to the amount of the change in the rise times of the sounds at the respective frequencies (Δt) in the predetermined frequency band, for example, the value of ratio Δf/Δt is larger when an anomaly is present in the adhesion state of a tile, and the value of ratio Δf/Δt is smaller when no anomaly is present in the adhesion state of the tile.

Next, upon detecting the presence or absence of an anomaly in the adhesion state of the tile in step S02, detector 12c of anomaly detection device 100 outputs, to presenter 14, information indicating the presence or absence of an anomaly in the adhesion state of the tile (not shown). Upon obtaining the information outputted from detector 12c, presenter 14 presents, to the user, whether an anomaly is present in the adhesion state of the tile (S03). Note that detector 12c may output the information indicating the presence or absence of an anomaly in the adhesion state of the tile to information terminal 200 via communicator 11. In this case, information terminal 200 may cause presenter 25 to present the information obtained via communicator 21.

For example, presenters 14, 25 may present, to the user, whether an anomaly is present in the adhesion state of a tile in the form of voice or image. The presence or absence of an anomaly in the adhesion state may be presented every time the presence or absence of an anomaly is detected in one tile, or only when an anomaly is present. When an anomaly is present in the adhesion state of a tile, for example, presenters 14, 25 may output a mechanical sound such as “beep” or “booboo”, or may output a voice message such as “anomalous, anomalous” or “anomaly is present”. Also, when no anomaly is present in the adhesion state of a tile, presenters 14, 25 may, for example, output sound such as “ping pong” or “OK”. Presenters 14, 25 may also display, on the display, a cross mark when an anomaly is present, and a circle mark when no anomaly is present. Presenter 14 may also project red light on a tile when an anomaly is present in such tile and blue light on a tile when no anomaly is present in such tile.

Presenters 14, 25 may collectively present the detection results on a plurality of tiles after completion of the anomaly detection for the adhesion states of the plurality of tiles. The user may set a form in which the detection results are presented as appropriate.

### [Example Operation in Detection Step]

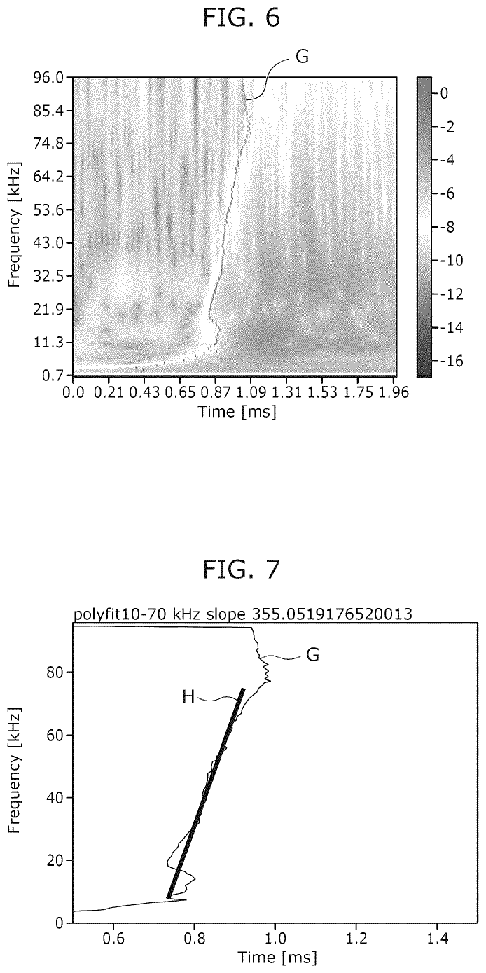

With reference to FIG. 5 and FIG. 6, an example operation performed by anomaly detection device 100 in the detection step (step S02 in FIG. 4) is described. FIG. 5 is a flowchart showing a detailed flow of step S02 in FIG. 4. FIG. 6 is a diagram showing an example of the tapping sound information on a tile. The tapping sound information on the tile shown in FIG. 6 is a scalogram image.

First, in the detection step, calculator 12b of anomaly detection device 100 extracts time-series data on the sounds at the respective frequencies from the tapping sound information on the tile obtained by obtainer 12a in step S01 (S11).

Next, calculator 12b calculates the rise times of the sounds at the respective frequencies, on the basis of the time-series data on the sounds at the respective frequencies extracted in step S11 (S12). More specifically, for example, calculator 12b selects the maximum value and the minimum value of the sound pressure in the time-series data on the sounds at the respective frequencies, and calculates, as the rise time of the sound at each frequency, the time at which the difference between the maximum value and the minimum value of the sound pressure at such frequency exceeds a predetermined percentage (e.g., 75%). When the rise times of the sounds at the respective frequencies are calculated, curve G shown in FIG. 6, for example, is shown on the scalogram image. Curve G indicates the rise times of the sounds at the respective frequencies calculated by calculator 12b.

Next, calculator 12b approximates, by a straight line, the rise times of the sounds at the respective frequencies calculated in step S12 in the predetermined frequency band, and calculates the numeric value of the slope of such straight line (S13).

Here, with reference to FIG. 6 and FIG. 7, step S13 is more specifically described. FIG. 7 is a diagram showing an example in which the rise times of the sounds at the respective frequencies are linearly approximated in the predetermined frequency band. In step S13, calculator 12b calculates, for example, the numeric value of the slope of approximate straight line H (see FIG. 7), which is obtained by approximating curve G (see FIG. 6) indicating the rise times of the sounds at the respective frequencies by a straight line in the predetermined frequency band (e.g., the frequency band between 10 kHz and 70 kHz, inclusive). The slope of approximate straight line H is, for example, 355. Note that calculator 12b may not calculate the rise times of the sounds at the respective frequencies (e.g., curve G) and the numeric value of the slope of approximate straight line H in the predetermined frequency band. For example, calculator 12b may calculate the rise times of sounds at two frequencies that are the previous and subsequent frequencies of the predetermined frequency (e.g., 40 kHz) in the predetermined frequency band, and calculate the numeric value of the slope of the line segment connecting these two calculated rise times of the sounds. Such numeric value of the slope of this line segment corresponds to ratio (Δf/Δt) described above. Stated differently, the difference between the rise times of the sounds at the respective frequencies in the predetermined frequency band may be the numeric value of the slope of the straight line connecting these two points, or may be the numeric value of the slope of approximate straight line H of curve G.

With reference to FIG. 5 again, detector 12c then obtains the numeric value of the slope of the straight line (approximate straight line) calculated by calculator 12b in step S13 (S14), and detects whether an anomaly is present in the adhesion state of the tile, on the basis of the obtained numeric value of the slope of the straight line (S15). With reference to FIG. 7, detector 12c determines that the adhesion state of the tile is anomalous, for example, on the basis of the numeric value (355) of the slope of approximate straight line H.

### [Example Operation 1 in Presentation Step]

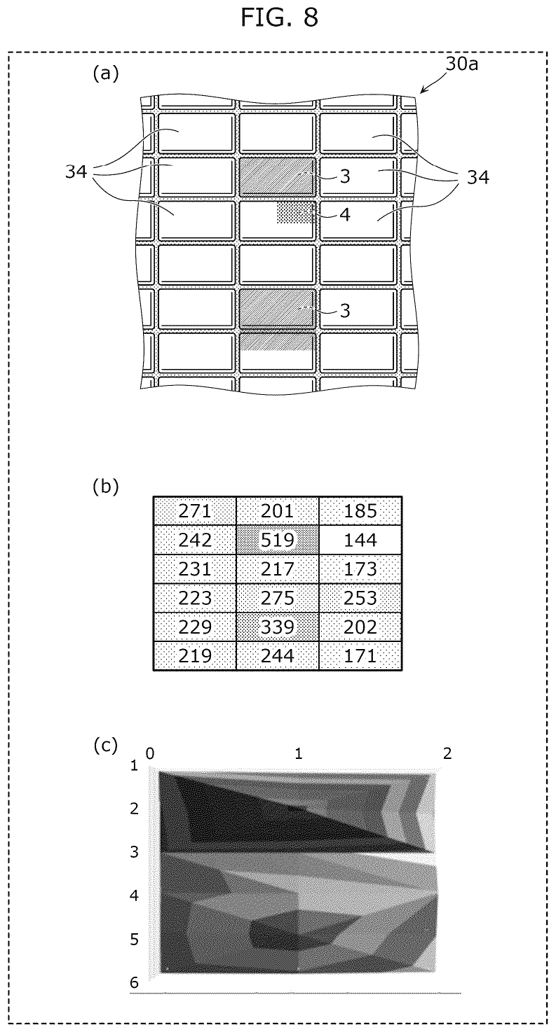

The following describes Example Operation 1 performed by anomaly detection device 100 in the presentation step, using tile specimen 30a. FIG. 8 is a diagram for explaining Example Operation 1 performed in the presentation step. (a) in FIG. 8 schematically shows the structure of tile specimen 30a. Tile specimen 30a is created by applying mortar to the surface of the concrete base used as a frame, and putting tiles 34 thereon. As shown in (a) in FIG. 8, to simulate concrete interface delamination, tile specimen 30a includes regions in which sheet protector 3 is placed between the concrete base and mortar, and a region in which styrene board 4 that is 3 mm in thickness is placed between the concrete base and mortar. The center of the surface of each tile 34 in tile specimen 30a was tapped once with a tapping rod (e.g., tapping means 1 in FIG. 2), and the picked-up tapping sound was wavelet-transformed to detect whether an anomaly is present in the adhesion state of tile 34, in accordance with the foregoing example operations.

Anomaly detection device 100 may present, to the user, the result of detecting the presence or absence of an anomaly in the adhesion state of each of tiles 34 in tile specimen 30a, for example, in the presentation forms shown in (b) and (c) in FIG. 8.

As shown in (b) in FIG. 8, presenter 14 may present whether an anomaly is present in the adhesion states of eighteen tiles 34, for example, in a tabular form in which the presence or absence of an anomaly in each of eighteen tiles 34 and the position of the tile are associated with each other. Presenter 14 may also present, to the user, a table showing the numeric value of the slope of the approximate straight line calculated for each tile 34, or a table showing the presence or absence of an anomaly (e.g., circle mark, cross mark) that is determined on the basis of the slope of the approximate straight line.

As shown in (c) in FIG. 8, presenter 14 may present, to the user, a contour line that connects the numeric values of the slopes of the approximate straight lines shown in (b) in FIG. 8 at predetermined value intervals. Presenter 14 may further present a region enclosed by the contour line with a color that differs depending on the magnitude of a numeric value. For example, a color may be changed to be closer to red as the numeric value of the slope of an approximate straight line is larger and to be closer to blue as such value is smaller. The color may also be changed to be darker as the numeric value of the slope of an approximate straight line is larger and to be paler as such value is smaller. By presenting, to the user, a contour line that connects the slopes of the straight lines of tiles 34 as in the foregoing manner, it is possible for the user to visually grasp an area in which an anomaly is present in the adhesion state of a tile. This increases the convenience of the user.

Note that anomaly detection device 100 may output the detection results to information terminal 200 used by the user and cause presenter 25 of information terminal 200 to present the detection results.

### [Example Operation 2 in Presentation Step]

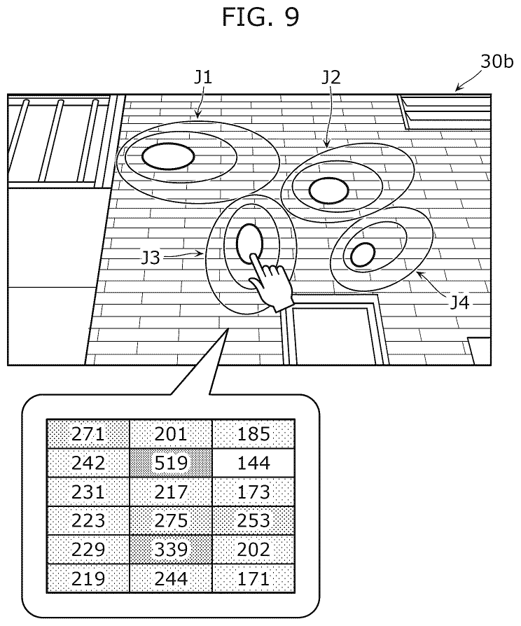

The following describes Example Operation 2 performed by anomaly detection device 100 in the presentation step. FIG. 9 is a diagram for explaining Example Operation 2 performed in the presentation step.

In Example Operation 2, information processor 12 of anomaly detection device 100 may cause presenter 14 to present a camera image of wall 30b to be inspected, for example, that is overlaid with contour lines that connect the slopes of the numeric values of the approximate straight lines of the plurality of tiles at predetermined value intervals. With this, it is possible for the user to accurately grasp areas (in this case, regions J1, J2, J3, and J4) where an anomaly is most likely to be present, for the plurality of tiles bonded to a wide area, such as the entire surface of a building.

Also, when the user touches region J3, for example, receiver 15 receives an input operation for selecting region J3. Presenter 14 may present a table showing the numeric values of the slopes of the approximate straight lines of a plurality of tiles located in region J3, in accordance with the received input operation. This enables the user to check specific numeric values as well, and thus more accurately grasp whether an anomaly is present in the adhesion states of the tiles.

### [4. Example Experiments]

Using a tile specimen, studies were conducted to examine (1) Effective methods of time-frequency analysis, (2) a predetermined percentage suitable for calculating the rise times of sounds, and (3) an SNR used to determine the upper limit of the predetermined frequency band.

### [Tile Specimen Used]

As with tile specimen 30a (see (a) in FIG. 8), a tile specimen was created by applying mortar to the surface of the concrete base used as a frame, and putting tiles 34 thereon. In each of the example experiments described below, only the configuration that differs from that of tile specimen 30a is described.

### [Tapping Method]

The center of the surface of each tile in the tile specimen was tapped once with a tapping rod.

### [Conditions for Sound Pick-Up]

The tapping sound generated by tapping each tile in accordance with the foregoing tapping method was picked up.
Microphone used: MEMS microphone
Sampling frequency: 192 kHz

### (1) Effective Method of Time-Frequency Analysis

An effective method of time-frequency analysis was examined in Example Experiments 1 to 3.

### [Example Experiment 1]

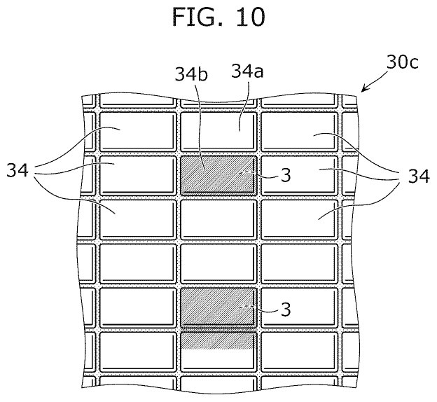

In Example Experiment 1, the effectiveness of wavelet transform was examined. In Example Experiment 1, tile specimen 30c was used. FIG. 10 is a diagram schematically showing the structure of tile specimen 30c.

As shown in FIG. 10, to simulate concrete interface delamination, tile specimen 30c includes regions in which sheet protector 3 is placed between the concrete base and mortar.

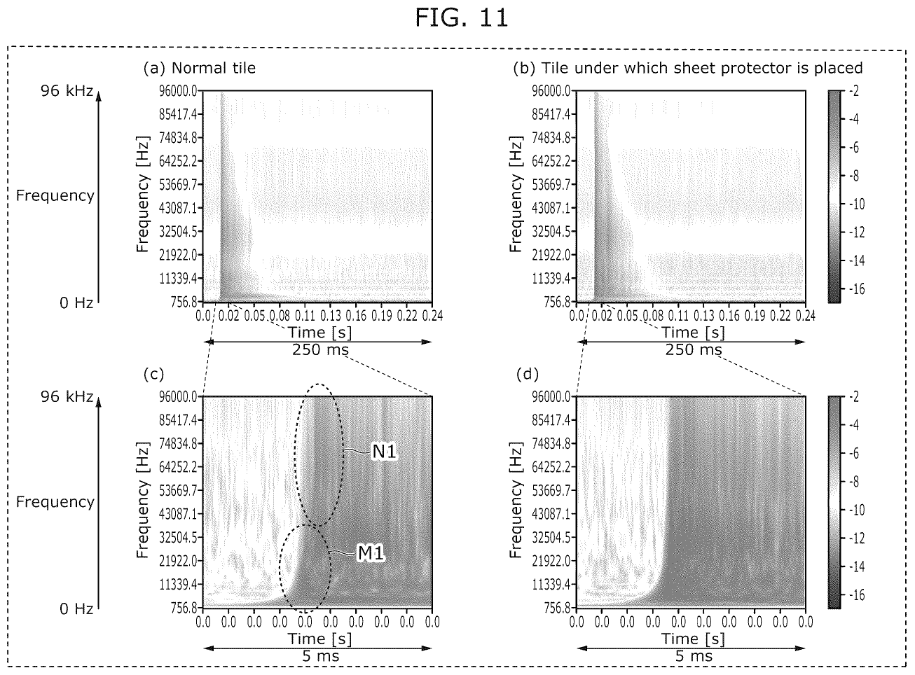

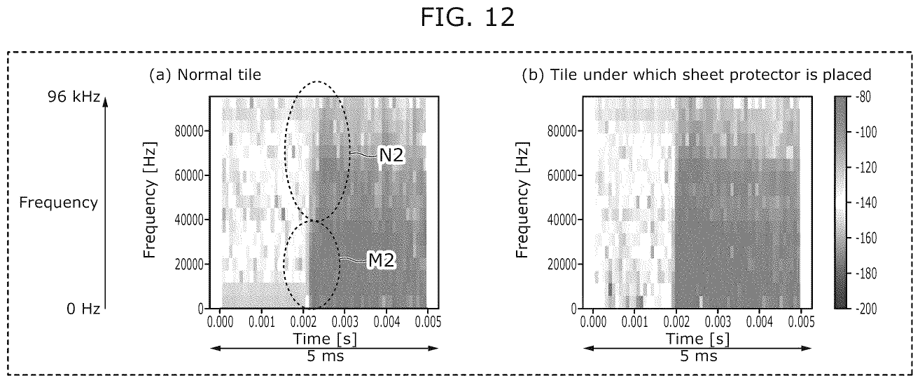

In Example Experiment 1, the tapping sounds of tile 34a and tile 34b in tile specimen 30c were picked up, and the electrical signals of the picked-up tapping sounds were AD converted, and then wavelet-transformed. The results are shown in FIG. 11.

FIG. 11 is a diagram showing the results of Example Experiment 1. In FIG. 11, (a) shows a wavelet transform image of the tapping sound of tile 34a whose adhesion state is normal, and (b) shows a wavelet transform image of the tapping sound of tile 34b in which concrete interface delamination was simulated.

To check for a difference between the rise times of the sounds in the ultrasonic range, wavelet transform images were generated for tile 34a and tile 34b, by cutting out 5 msec before and after the moment at which the tiles were tapped from (a) and (b) in FIG. 11, respectively, (see (c) and (d) in FIG. 11).

For tile 34a whose adhesion state is normal, a shift was observed in the rise times of the sounds at around 40 kHz, as shown in (c) in FIG. 11. (c) in FIG. 11 shows that, for the tile whose adhesion state is normal, the rise times of the sounds at the frequencies in high frequency range N1 including frequencies at 40 kHz or higher is later than the rise times of the sounds at the frequencies in low frequency range M1 including frequencies between 10 kHz and 40 kHz, inclusive.

Meanwhile, for tile 34b in which concrete interface delamination was simulated, no shift was observed in the rise times of the sounds in the high frequency band at 40 kHz or higher, as shown in (d) in FIG. 11. (d) in FIG. 11 shows that no shift occurs in the rise times of the sounds for the tile whose adhesion state is anomalous.

It was validated, therefore, that the use of wavelet transform images enables the determination of whether an anomaly is present in the adhesion states of tiles, on the basis of the difference between the rise times of the sounds at the respective frequencies in the predetermined frequency band that includes the inaudible range.

### [Example Experiment 2]

In Example Experiment 2, the effectiveness of Fourier transform was examined. Example Experiment 2 was conducted in the same manner as Example Experiment 1, excluding that Fourier transform (FFT size 32, overlap 16) was performed. The results are shown in FIG. 12.

FIG. 12 is a diagram showing the results of Example Experiment 2. In FIG. 12, (a) shows a Fourier transform image of the tapping sound of tile 34a whose adhesion state is normal, and (b) shows a Fourier transform image of the tapping sound of tile 34b in which concrete interface delamination was simulated. (a) and (b) in FIG. 12 show Fourier transform images generated by cutting out 5 msec before and after the moment at which tiles 34a and 34b were tapped, respectively.

For tile 34a whose adhesion state is normal, a shift was observed in the rise times of the sounds at around 40 kHz, as shown in (a) in FIG. 12. (a) in FIG. 12 shows that, for the tile whose adhesion state is normal, the rise times of the sounds at the frequencies in high frequency range N2 including frequencies at 40 kHz or higher are later than the rise times of the sounds at the frequencies in low frequency range M2 including frequencies at 40 kHz or below.

Meanwhile, for tile 34b in which concrete interface delamination was simulated, no shift occurs in the rise times of the sounds in the high frequency range at 40 kHz or higher as shown in (b) in FIG. 12. (b) in FIG. 12 shows that no shift occurs in the rise times of the sounds for the tile whose adhesion state is anomalous.

It was validated, therefore, that the use of Fourier transform images also enables the determination of whether an anomaly is present in the adhesion states of tiles, on the basis of the difference between the rise times of the sounds at the respective frequencies in the predetermined frequency band that includes the inaudible range, as with the wavelet transform images used in Example Experiment 1.

### [Example Experiment 3]

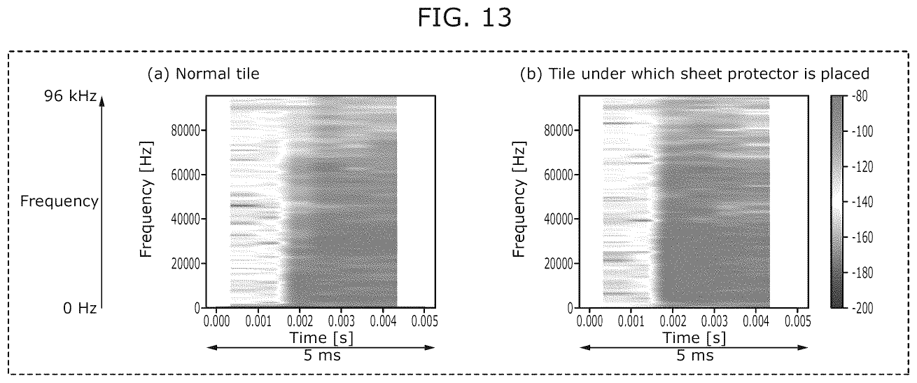

In Example Experiment 3, the effectiveness of Fourier transform was examined, using an FFT size that is different from the FFT size used in Example Experiment 2. Example Experiment 3 was conducted in the same manner as Example Experiment 2, excluding that Fourier transform (FFT size 256, overlap 128) was performed. The results are shown in FIG. 13.

FIG. 13 is a diagram showing the results of Example Experiment 3. In FIG. 13, (a) shows a Fourier transform image of the tapping sound of tile 34a whose adhesion state is normal, and (b) shows a Fourier transform image of the tapping sound of tile 34b in which concrete interface delamination was simulated. (a) and (b) in FIG. 13 show Fourier transform images generated by cutting out 5 msec before and after the moment at which the tiles were tapped as in Example Experiment 2.

For tile 34a whose adhesion state is normal, a shift was observed in the rise times of the sounds as shown in (a) in FIG. 13, and for tile 34b in which concrete interface delamination was simulated, no shift was observed in the rise times of the sounds as shown in (b) in FIG. 13.

It was validated, therefore, that the use of Fourier transform images also enables the determination of whether an anomaly is present in the adhesion states of tiles, on the basis of the difference between the rise times of the sounds at the respective frequencies in the predetermined frequency band that includes the inaudible range, as with the wavelet transform images used in Example Experiment 1.

### (2) Predetermined Percentage Suitable for Calculating Rise Times of Sound

In Example Experiments 4 and 5, a predetermined percentage suitable for calculating the rise times of sounds was examined. Each of the rise times of the sounds at the respective frequencies is the time at which a difference between the maximum value and the minimum value of the sound pressure at such frequency exceeds a predetermined percentage.

### [Example Experiment 4]

In Example Experiment 4, a predetermined percentage suitable for calculating the rise times of the sounds was examined, using normal tiles. In Example Experiment 4, tile specimen 30a (see (a) in FIG. 8) was used.

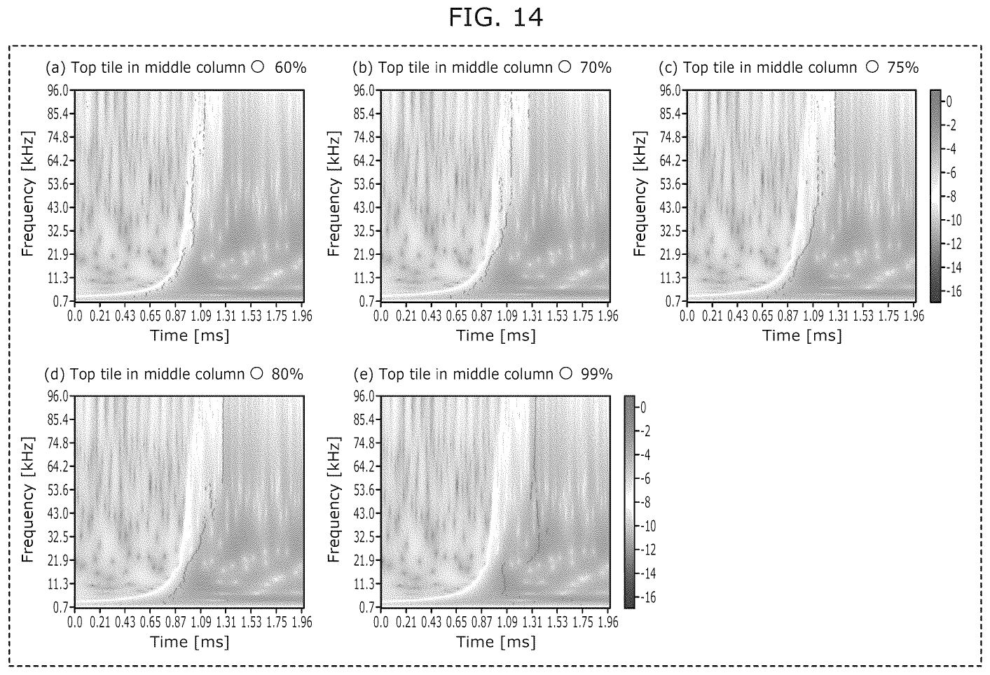

In Example Experiment 4, the tapping sound of the tile in the top row in the middle column in tile specimen 30a was picked up, and the electrical signal of the picked-up tapping sound was AD converted. Then, 2 msec before and after the moment at which the tile was tapped was cut out to be wavelet-transformed. Then, in calculating the rise times of the sounds at the respective frequencies, the percentage of the difference between the maximum value and the minimum value of the sound pressure at each frequency was changed to be 60%, 70%, 75%, 80%, and 99% to be examined. The results are shown in FIG. 14. FIG. 14 is a diagram showing the results of Example Experiment 4. The results of Example Experiment 4 will be described together with the results of Example Experiment 5.

### [Example Experiment 5]

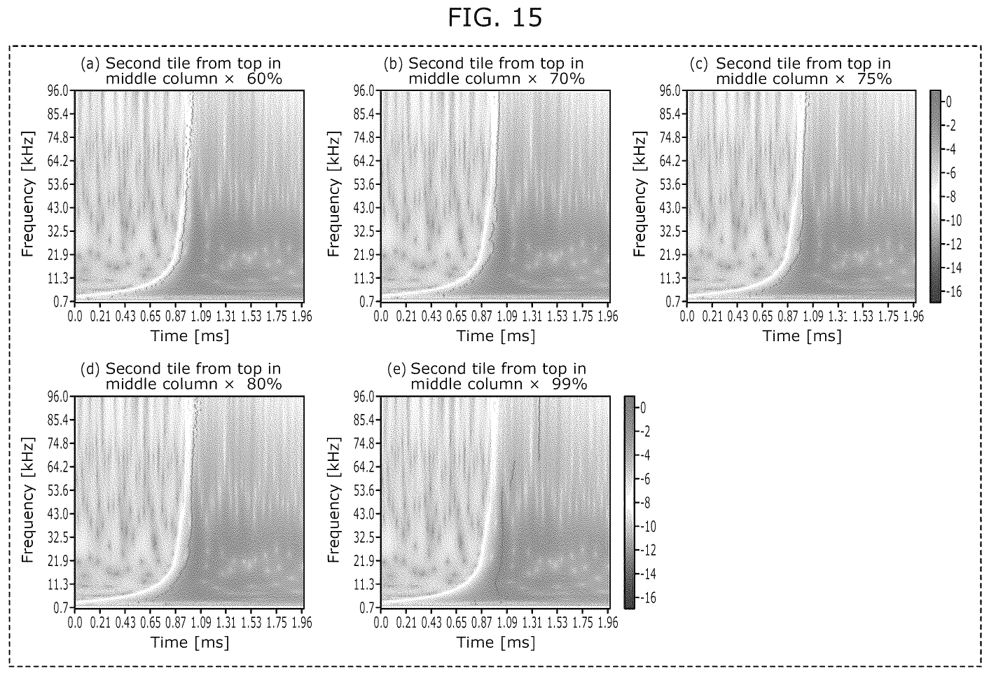

Example Experiment 5 was conducted in the same manner as Example Experiment 4, excluding that the tapping sound of the tile in the second row from the top in the middle column in tile specimen 30a was used. The results are shown in FIG. 15. FIG. 15 is a diagram showing the results of Example Experiment 5.

When considered together with the results of Example Experiment 4, at 99% (see (e) in FIG. 14 and (e) in FIG. 15) and at 80% (see (d) in FIG. 14 and (d) in FIG. 15), the rise times appeared to be determined later than the rise times determined by visual inspection of the images. Meanwhile, at 75% (see (c) in FIG. 14 and (c) in FIG. 15), the rise times appeared to generally coincide with the rise times determined by visual inspection of the images. It was thus determined that the rise times should be determined at 75%. (3) SNR for determining upper limit of predetermined frequency band

### [Example Experiment 6]

In Example Experiment 6, an SNR was examined that is used to determine the upper limit of the predetermined frequency band for linearly approximating the frequencies and the rise times of tapping sounds. In Example Experiment 6, tile specimen 30a (see (a) in FIG. 8) was used.

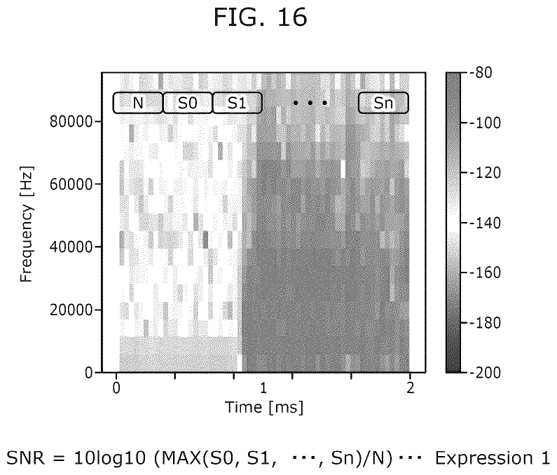

In Example Experiment 6, the tapping sounds of six tiles in the middle column of tile specimen 30a were picked up, and the electrical signals of the picked-up tapping sounds were AD-converted. Then, 2 msec before and after the moment at which each tile was tapped was cut out to be Fourier-transformed (FFT size 64 samples, overlap 32 samples). FIG. 16 is a diagram showing an example of the spectrogram image generated through Fourier transform in Example Experiment 6 and the formula (Expression 1) for calculating an SNR (signal-to-noise ratio).

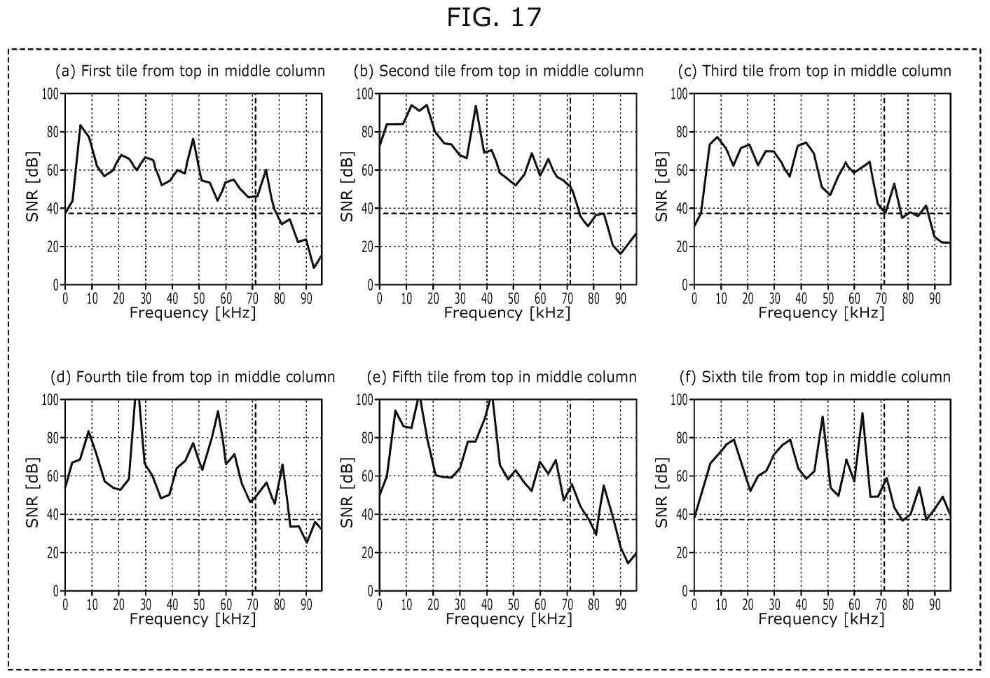

As shown in FIG. 16, power was measured at each frequency, taking the portion in the spectrogram image without a tapping sound as “N”. Next, power of the portion to the right of N was measured at the same time width, and the largest value was taken as “S0”. This was sequentially repeated, and the SNR values in each frequency band were calculated using Expression 1. The calculation results are shown in FIG. 17. FIG. 17 is a diagram showing the results of the SNR calculations in Example Experiment 6.

As shown in FIG. 17, although variations are present depending on the tapping sounds of the tiles, the SNRs were found to be generally 40 dB or higher, when the upper limit of the frequencies used for linear approximation was set at 70 kHz or lower.

It was validated, therefore, that the upper limit of the predetermined frequency band for linearly approximating the frequencies and the rise times of a tapping sound may be, for example, a frequency in the inaudible range at which the SNR is 40 dB or higher.

### [5. Effects and Others]

As described above, anomaly detection device 100 according to the embodiment includes: obtainer 12c that obtains tapping sound information indicating a tapping sound generated by tapping a tile that is bonded; and detector 12c that detects, from the tapping sound information, whether an anomaly is present in an adhesion state of the tile, based on a difference between rise times of sounds at respective frequencies in a predetermined frequency band that includes an inaudible range.

With this, it is possible for anomaly detection device 100 to detect whether an anomaly is present in the adhesion state of a tile, on the basis of a difference between the rise times of the sounds at the respective frequencies in the predetermined frequency band. This eliminates the user's trouble of having to determine the presence or absence of an anomaly. It is thus possible for anomaly detection device 100 to detect whether an anomaly is present in the adhesion state of a tile in an easy and accurate manner.

In anomaly detection device 100 according to the embodiment, the difference between the rise times of the sounds may be a ratio (Δf/Δt) of an amount of change in the respective frequencies (Δf) to an amount of change in the rise times of the sounds (Δt) at the respective frequencies in the predetermined frequency band.

With this, it is possible for anomaly detection device 100 to detect whether an anomaly is present in the adhesion state of the tile, on the basis of the rate of change of the rise times of the sounds at the respective frequencies in the predetermined frequency band (i.e., ratio Δf/Δt described above).

Anomaly detection device 100 according to the embodiment may further include calculator 12b that calculates the difference between the rise times of the sounds. In anomaly detection device 100, calculator 12b may: extract, from the tapping sound information, time-series data on the sounds at the respective frequencies; approximate, by a straight line, the rise times of the sounds at the respective frequencies in the predetermined frequency band (e.g., between 10 kHz and 70 kHz, inclusive), based on the time-series data on the sounds at the respective frequencies; and calculate, as the ratio, a numeric value of a slope of the straight line.

With this, it is possible for anomaly detection device 100 to detect whether an anomaly is present in the adhesion state of the tile, on the basis of the slope of the straight line, which is obtained by linearly approximating the rise times of the sounds at the respective frequencies in the predetermined frequency band. With this, it is possible for anomaly detection device 100 to detect whether an anomaly is present in the adhesion state of the tile, on the basis of the relationship between the frequencies and the rise times of the sounds.

In anomaly detection device 100 according to the embodiment, a lower limit of the predetermined frequency band may be a frequency that corresponds to a predetermined period (e.g., 0.1 msec) in which the rise times of the sounds at the respective frequencies are measured.

With this, it is possible for anomaly detection device 100 to set the lower limit of the predetermined frequency band in accordance with the measurement accuracy required by the user.

In anomaly detection device 100 according to the embodiment, an upper limit of the predetermined frequency band may be in the inaudible range and a frequency at which a signal-to-noise ratio is greater than or equal to a predetermined value (e.g., 40 dB).

With this, the upper limit frequency is set to a frequency, among the frequencies in the inaudible range, that is lower than or equal to the frequency at which noise of a certain level or higher exists. It is thus possible for anomaly detection device 100 to detect whether an anomaly is present in the adhesion state of the tile, on the basis of highly reliable data. Anomaly detection device 100 is thus capable of improving the accuracy of detecting an anomaly in the adhesion state of the tile.

In anomaly detection device 100 according to the embodiment, each of the rise times of the sounds may be time at which a difference between a maximum value and a minimum value of a sound pressure exceeds a predetermined percentage (e.g., 75%).

With this, it is possible for anomaly detection device 100 to accurately measure the rise times of the sounds at the respective frequencies, even when the sound pressures at the respective frequencies are different.

Anomaly detection device 100 according to the embodiment may further include presenter 14 that presents information to a user. In anomaly detection device 100, presenter 14 may present the information indicating whether an anomaly is present in the adhesion state of the tile.

With this, it is possible for anomaly detection device 100 to present, to the user, whether an anomaly is present in the adhesion state of the tile, thereby assisting the user in easily grasping the presence or absence of an anomaly in the adhesion state of the tile.

Anomaly detection device 100 according to the embodiment may further include presenter 14 that presents information to a user. In anomaly detection device 100, presenter 14 may present the information in a form of a contour line that connects numeric values of slopes of straight lines of a plurality of tiles at a predetermined value interval, the numeric values of the slopes of the straight lines of the plurality of tiles each being the numeric value of the slope of the straight line of the tile.

With this, it is possible for anomaly detection device 100 to, for example, assist the user in easily grasping an area where an anomaly is likely to be present on a wall surface of a certain size range.

Also, the anomaly detection method according to the embodiment is an anomaly detection method performed by a computer. This anomaly detection method includes: obtaining tapping sound information indicating a tapping sound generated by tapping a tile that is bonded (S01 in FIG. 4); and detecting, from the tapping sound information, whether an anomaly is present in an adhesion state of the tile, based on a difference between rise times of sounds at respective frequencies in a predetermined frequency band that includes an inaudible range(S02 in FIG. 4).

With this, it is possible for a device that performs the anomaly detection method to detect whether an anomaly is present in the adhesion state of a tile, on the basis of a difference between the rise times of sounds at the respective frequencies in the predetermined frequency band. This eliminates the user's trouble of having to determine the presence or absence of an anomaly. It is thus possible for the device that performs the anomaly detection device to detect whether an anomaly is present in the adhesion state of a tile in an easy and accurate manner.

### Other Embodiments

The embodiment has been described above, but the present disclosure is not limited to the foregoing embodiment.

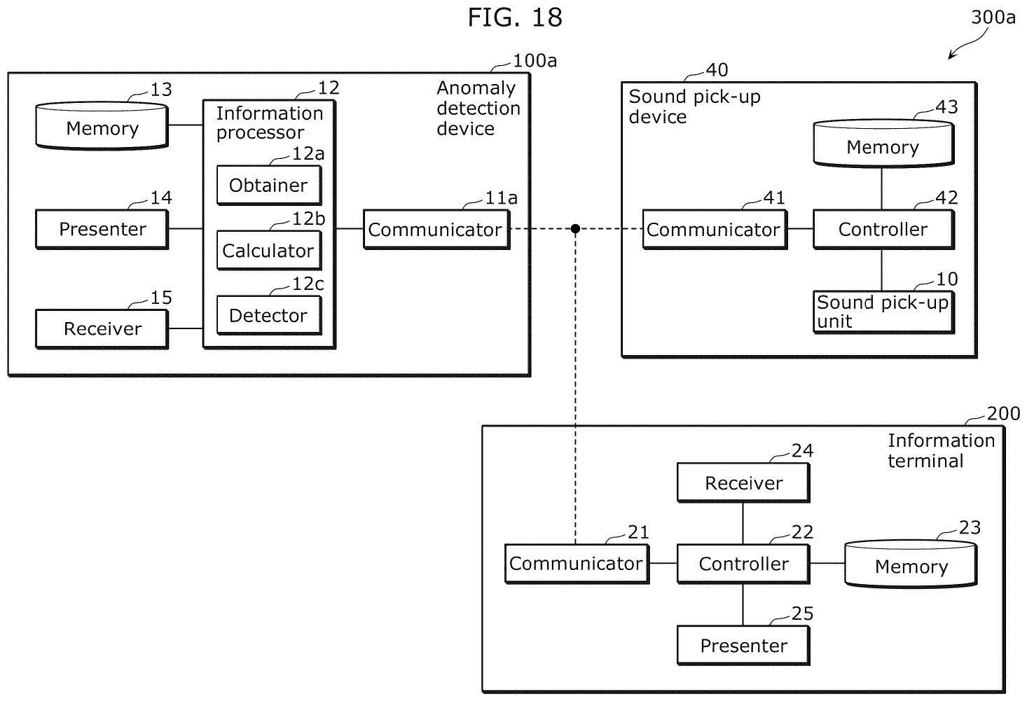

For example, in the embodiment, anomaly detection device 100 includes sound pick-up unit 10, but may not include sound pick-up unit 10. FIG. 18 is a block diagram showing an example of the functional configuration of an anomaly detection system in another embodiment.

As shown in FIG. 18, anomaly detection system 300a in another embodiment may include, for example, anomaly detection device 100a, sound pick-up device 40, and information terminal 200.

Anomaly detection device 100a is different from anomaly detection device 100 in that anomaly detection device 100a does not include sound pick-up unit 10, and includes communicator 11a, which is a communication circuit for communicating with sound pick-up device 40 and information terminal 200. Sound pick-up device 40 is communicably connected to anomaly detection device 100a and information terminal 200 via communicator 41, and includes controller 42 which performs various information processing relating to sound pick-up device 40, and memory 43 in which, for example, data on sounds picked up by sound pick-up unit 10, a computer program, etc. are stored.

Anomaly detection device 100a may be, for example, a stationary or portable personal computer, or may be a server device. Anomaly detection device 100a obtains, via communicator 11a, an electrical signal of the tapping sound of a tile picked up by sound pick-up unit 10 of sound pick-up device 40. With this, anomaly detection device 100a is capable of executing the anomaly detection method by installing, in a computer, an application program for executing the anomaly detection method.

Also, for example, in the foregoing embodiments, anomaly detection systems 300, 300a are realized by means of a plurality of devices, but may also be realized by means of a single device. In the case where the system is realized by means of a plurality of devices, the elements included in anomaly detection systems 300, 300a may be allocated to the plurality of devices in any manner. Also, for example, a server device capable of communicating with anomaly detection systems 300, 300a may include the plurality of elements included in information processor 12.

For example, a method of communication performed between devices described in the foregoing embodiments is not limited to a specific method. Also, a relay device not shown may be present in communication performed between devices.

Also, in the foregoing embodiments, a process performed by a specified processing unit may be performed by another processing unit. Also, the processing order of a plurality of processes may also be changed, and a plurality of processes may be performed in parallel.

Also, in the foregoing embodiments, each of the elements may be realized by means of executing a software program suitable for the element. Each of the elements may be realized by means of a program executing unit, such as a CPU and a processor, reading and executing the software program recorded on a recording medium such as a hard disk or a semiconductor memory.

Also, each of the elements may be configured in the form of an exclusive hardware product. Also, each of the elements may be a circuit (or an integrated circuit). Each of the circuits may be configured in the form of one circuit as a whole, or in the form of individual circuits. Each of the circuits may be a general-purpose circuit or an exclusive circuit.

These general and specific aspects of the present disclosure may be implemented using a system, a device, a method, an integrated circuit, a computer program, or a computer-readable recording medium such as a CD-ROM, or any combination of systems, devices, methods, integrated circuits, computer programs, or computer-readable recording media.

For example, the present disclosure may be implemented in the form of an anomaly detection method executed by a computer such as anomaly detection devices 100, 100a, or information terminal 200, or may be implemented in the form of a program for causing a computer to execute such anomaly detection method. The present disclosure may also be implemented in the form of programs for causing a general-purpose computer to operate as anomaly detection devices 100, 100a, or information terminal 200 in the foregoing embodiments. The present disclosure may also be implemented in the form of a non-transitory computer-readable recording medium having recorded thereon these programs.

The scope of the present disclosure also includes an embodiment achieved by making various modifications to each of the embodiments that can be conceived by those skilled in the art, and an embodiment achieved by freely combining some of the elements and functions in each of the embodiments without departing from the essence of the present disclosure.

### (Added Notes)

The following illustrates technologies obtained from the contents of the disclosure of the present specification, and describes effects and others obtained from these technologies.

### [Technology 1]

An anomaly detection device including:
an obtainer that obtains tapping sound information indicating a tapping sound generated by tapping a tile that is bonded; and
a detector that detects, from the tapping sound information, whether an anomaly is present in an adhesion state of the tile, based on a difference between rise times of sounds at respective frequencies in a predetermined frequency band that includes an inaudible range.

### [Effect of Technology 1]

With this, it is possible for the anomaly detection device to detect whether an anomaly is present in the adhesion state of a tile, on the basis of a difference between the rise times of sounds at the respective frequencies in the predetermined frequency band. This eliminates the user's trouble of having to determine the presence or absence of an anomaly. It is thus possible for the anomaly detection device to detect whether an anomaly is present in the adhesion state of a tile in an easy and accurate manner.

### [Technology 2]

The anomaly detection device according to technology 1, wherein the difference between the rise times of the sounds is a ratio of an amount of change in the respective frequencies to an amount of change in the rise times of the sounds at the respective frequencies in the predetermined frequency band.

### [Effect of Technology 2]

With this, it is possible for the anomaly detection device to detect whether an anomaly is present in the adhesion state of the tile, on the basis of the rate of change of the rise times of the sounds at the respective frequencies in the predetermined frequency band (i.e., the foregoing ratio).

### [Technology 3]

The anomaly detection device according to technology 2, further including:
a calculator that calculates the difference between the rise times of the sounds,
wherein the calculator:
   extracts, from the tapping sound information, time-series data on the sounds at the respective frequencies;
   approximates, by a straight line, the rise times of the sounds at the respective frequencies in the predetermined frequency band, based on the time-series data on the sounds at the respective frequencies; and
   calculates, as the ratio, a numeric value of a slope of the straight line.

### [Effect of Technology 3]

With this, it is possible for the anomaly detection device to detect whether an anomaly is present in the adhesion state of the tile, on the basis of the slope of the straight line, which is obtained by linearly approximating the rise times of the sounds at the respective frequencies in the predetermined frequency band. With this, it is possible for the anomaly detection device to detect whether an anomaly is present in the adhesion state of the tile, on the basis of the relationship between the frequencies and the rise times of the sounds.

### [Technology 4]

The anomaly detection device according to any one of technologies 1 to 3,
wherein a lower limit of the predetermined frequency band is a frequency that corresponds to a predetermined period in which the rise times of the sounds at the respective frequencies are measured.

### [Effect of Technology 4]

With this, it is possible for the anomaly detection device to set the lower limit of the predetermined frequency band in accordance with the measurement accuracy required by the user.

### [Technology 5]

The anomaly detection device according to any one of technologies 1 to 4,
wherein an upper limit of the predetermined frequency band is in the inaudible range and a frequency at which a signal-to-noise ratio is greater than or equal to a predetermined value.

### [Effect of Technology 5]

With this, the upper limit frequency is set to a frequency, among the frequencies in the inaudible range, that is lower than or equal to the frequency at which noise of a certain level or higher exists. It is thus possible for the anomaly detection device to detect whether an anomaly is present in the adhesion state of the tile, on the basis of highly reliable data. The anomaly detection device is thus capable of improving the accuracy of detecting an anomaly in the adhesion state of the tile.

### [Technology 6]

The anomaly detection device according to any one of technologies 1 to 5,
wherein each of the rise times of the sounds is time at which a difference between a maximum value and a minimum value of a sound pressure exceeds a predetermined percentage.

### [Effect of Technology 6]

With this, it is possible for the anomaly detection device to accurately measure the rise times of the sounds at the respective frequencies, even when the sound pressures at the respective frequencies are different.

### [Technology 7]

The anomaly detection device according to any one of technologies 1 to 6, further including:
a presenter that presents information to a user,
wherein the presenter presents the information indicating whether an anomaly is present in the adhesion state of the tile.

### [Effect of Technology 7]

With this, it is possible for the anomaly detection device to present, to the user, whether an anomaly is present in the adhesion state of the tile, thereby assisting the user in easily grasping the presence or absence of an anomaly in the adhesion state of the tile.

### [Technology 8]

The anomaly detection device according to technology 3, further including:
a presenter that presents information to a user,
wherein the presenter presents the information in a form of a contour line that connects numeric values of slopes of straight lines of a plurality of tiles at a predetermined value interval, the numeric values of the slopes of the straight lines of the plurality of tiles each being the numeric value of the slope of the straight line of the tile.

### [Effect of Technology 8]

With this, it is possible for the anomaly detection device to, for example, assist the user in easily grasping an area where an anomaly is likely to be present on a wall surface of a certain size range.

### INDUSTRIAL APPLICABILITY

According to the present disclosure, it is possible to detect whether an anomaly is present in the adhesion state of a tile in an easy and accurate manner, thereby reducing the burden on a worker who performs a hammering inspection on a structure.

1. An anomaly detection device comprising:
an obtainer that obtains tapping sound information indicating a tapping sound generated by tapping a tile that is bonded; and
a detector that detects, from the tapping sound information, whether an anomaly is present in an adhesion state of the tile, based on a difference between rise times of sounds at respective frequencies in a predetermined frequency band that includes an inaudible range.

2. The anomaly detection device according to claim 1,
wherein the difference between the rise times of the sounds is a ratio of an amount of change in the respective frequencies to an amount of change in the rise times of the sounds at the respective frequencies in the predetermined frequency band.

3. The anomaly detection device according to claim 2, further comprising:
a calculator that calculates the difference between the rise times of the sounds,
wherein the calculator:
extracts, from the tapping sound information, time-series data on the sounds at the respective frequencies;
approximates, by a straight line, the rise times of the sounds at the respective frequencies in the predetermined frequency band, based on the time-series data on the sounds at the respective frequencies; and
calculates, as the ratio, a numeric value of a slope of the straight line.

4. The anomaly detection device according to claim 1,
wherein a lower limit of the predetermined frequency band is a frequency that corresponds to a predetermined period in which the rise times of the sounds at the respective frequencies are measured.

5. The anomaly detection device according to claim 1,
wherein an upper limit of the predetermined frequency band is in the inaudible range and a frequency at which a signal-to-noise ratio is greater than or equal to a predetermined value.

6. The anomaly detection device according to claim 1,
wherein each of the rise times of the sounds is time at which a difference between a maximum value and a minimum value of a sound pressure exceeds a predetermined percentage.

7. The anomaly detection device according to claim 1, further comprising:
a presenter that presents information to a user,
wherein the presenter presents the information indicating whether an anomaly is present in the adhesion state of the tile.

8. The anomaly detection device according to claim 3, further comprising:
a presenter that presents information to a user,
wherein the presenter presents the information in a form of a contour line that connects numeric values of slopes of straight lines of a plurality of tiles at a predetermined value interval, the numeric values of the slopes of the straight lines of the plurality of tiles each being the numeric value of the slope of the straight line of the tile.

9. An anomaly detection method performed by a computer, the anomaly detection method comprising:
obtaining tapping sound information indicating a tapping sound generated by tapping a tile that is bonded; and
detecting, from the tapping sound information, whether an anomaly is present in an adhesion state of the tile, based on a difference between rise times of sounds at respective frequencies in a predetermined frequency band that includes an inaudible range.

10. A non-transitory computer-readable recording medium having recorded thereon a program for causing a computer to execute the anomaly detection method according to claim 9.
